(19) United States
(12) Patent Application Publication
(10) Pub. No.: US 2022/0083962 A1
(43) Pub. Date: Mar. 17, 2022

(54) METHOD AND SYSTEM FOR PROCESSING CUSTOMS FORMS ASSOCIATED WITH A SHIPMENT

(71) Applicant: AI DOCK LTD, Rehovot (IL)

(72) Inventors: Sean GALANTZAN, Rehovot (IL); Eddie GALANTZAN, Rehovot (IL); Tomer SHAMIR, Rehovot (IL)

(21) Appl. No.: 17/309,497

(22) PCT Filed: Jan. 2, 2020
(86) PCT No.: PCT/IL2020/050006

§ 371 Date: Jun. 1, 2021

Related U.S. Application Data
(60) Provisional application No. 62/787,771, filed on Jan. 3, 2019.

(51) Int. Cl. G06Q 10/08; G06Q 30/00

(52) U.S. Cl. CPC G06Q 10/0831; G06Q 30/018

(57) ABSTRACT

Methods and systems for preparing a shipment for customs clearance, for example, by a national customs authority, include obtaining one or more electronic documents associated with a shipment of goods and obtaining one or more electronic customs forms of a customs authority. The electronic documents are processed by an automated system which recognizes the documents by document type and extracts data from each document, based on its determined document type. The extracted data is merged into an object for all of the electronic forms associated with the shipment of goods, and from this merged object, the obtained customs forms are completed. These completed forms are transmitted to the customs authority directly from the system.

### CROSS-REFERENCE TO RELATED APPLICATIONS

This application is related to and claims priority from commonly owned U.S. Provisional Patent Application Ser. No. 62/787,771, entitled: Method and System for Processing Customs Forms Associated with a Shipment, filed on Jan. 3, 2019, the disclosure of which is incorporated by reference in its entirety herein.

### TECHNICAL FIELD

The present invention is directed to methods and systems for processing customs documents associated with a shipment of goods.

### BACKGROUND

The processing of customs documents associated with shipments has remained unchanged since the early 1900s. The process of customs document review is manual, time consuming and subject to human error, such as an inspector missing documents as they simply do not know the requirements for the particular goods. This results in goods not permitted by a country, entering the country.

### SUMMARY OF THE INVENTION

The present invention provides methods and systems which allow for the automatic and accurate processing of customs documents associated with shipped goods.

Embodiments of the invention are directed to a method for preparing a shipment for customs clearance, for example, by a national customs authority. The method comprises: obtaining one or more electronic documents associated with a shipment of goods; obtaining one or more electronic customs forms of a customs authority; automatically classifying each electronic document of the one or more electronic documents into document types for processing based on each classified document type; automatically processing each document in accordance with its classified document type to obtain one or more text fields, and merging all obtained text fields into an object representing the one or more electronic documents associated with the shipment of goods; determining, by a processor, whether all of the documents and data associated with the shipment of goods, are present by comparing all of the text fields of the object for matches against text fields of a checklist associated with the customs authority; and, should a required number text fields match, by a processor, automatically completing the customs forms for the shipment based on the data of the object. The processor may be, for example a graphics processing unit (GPU), and/or a central processing unit (CPU), which are, for example, both in a processing unit of the invention.

Optionally, the method is such that it additionally comprises: providing documents associated with the completed customs forms to form a document package for the customs authority.

Optionally, the method is such that it additionally comprises: automatically transmitting the completed customs form or the document package to the customs authority.

Optionally, the method is such that, the document types include one or more of: commercial invoices, packaging lists, airway bills, country of origin, bills of lading, dangerous goods declarations, import permits, materials safety data sheets, and shipping instructions.

Optionally, the method is such that it additionally comprises: automatically providing a harmonized system (HS) code for the shipment of goods.

Optionally, the method is such that it additionally comprises: automatically obtaining customs tariffs and/or taxes for the shipment of goods.

Optionally, the method is such that it additionally comprises: automatically determining, by a processor, whether the shipment of goods has the proper permits required by the customs authority, and if the required permits are not present, automatically sending an alert of the missing permits to at least one party associated with the shipment of goods.

Optionally, the method is such that it additionally comprises: should the required number text fields not match, by a processor, automatically sending an alert that the required text fields are not present to at least one party associated with the shipment of goods.

Optionally, the method is such that the automatically completing the customs forms for the shipment based on the data of the object is performed by a template engine.

Embodiments of the invention are directed to a computer system for preparing a shipment for customs clearance. The computer system comprises: a reader for reading electronic documents associated with a shipment of goods; a storage medium for storing computer components; and, at least one processor for executing the computer components. The computer components comprise: a first computer component for obtaining one or more electronic documents associated with the shipment of goods, and one or more customs forms of a customs authority; a second computer component for automatically classifying each electronic document of the one or more electronic documents into document types for processing based on each classified document type, based on data from the one or more electronic documents read by the reader; a third computer component for automatically processing each document in accordance with its classified document type to obtain one or more text fields, based on said each document being read by the reader, and merging all obtained text fields into an object representing the one or more electronic documents associated with the shipment of goods; a fourth computer component for determining, whether all of the documents and data associated with the shipment of goods, are present by comparing all of the text fields of the object for matches against text fields of a checklist associated with the customs authority; and, a fifth computer component responsive to a determination that a required number text fields match, automatically completing the customs forms for the shipment based on the data of the object.

Optionally, the computer system is such that it additionally comprises: a sixth computer component for automatically transmitting the completed customs form to the customs authority.

Optionally, the computer system is such that the document types include one or more of: commercial invoices, packaging lists, airway bills, country of origin, bills of lading, dangerous goods declarations, import permits, materials safety data sheets, and shipping instructions.

Optionally, the computer system is such that it additionally comprises: a seventh computer component for automatically providing a harmonized system (HS) code for the shipment of goods.

Optionally, the computer system is such that it additionally comprises: an eighth computer component for automatically obtaining customs tariffs and/or taxes for the shipment of goods.

Optionally, the computer system is such that it additionally comprises: a ninth computer component for automatically determining whether the shipment of goods has the proper permits required by the customs authority, and if the required permits are not present, automatically sending an alert of the missing permits to at least one party associated with the shipment of goods.

Optionally, the computer system is such that the fourth computer component is additionally configured to respond, when the required number text fields do not match, by automatically sending an alert that the required text fields are not present to at least one party associated with the shipment of goods.

Optionally, the computer system is such that the fifth computer component includes a template engine for automatically completing the customs forms for the shipment based on the data of the object.

Embodiments of the invention are directed to a computer usable non-transitory storage medium having a computer program embodied thereon for causing a suitably programmed system to preparing a shipment for customs clearance, by performing the following steps when such program is executed on the system. The steps comprise: obtaining one or more electronic documents associated with a shipment of goods; obtaining one or more electronic customs forms of a customs authority; automatically classifying each electronic document of the one or more electronic documents into document types for processing based on each classified document type; automatically processing each document in accordance with its classified document type to obtain one or more text fields, and merging all obtained text fields into an object representing the one or more electronic documents associated with the shipment of goods; determining whether all of the documents and data associated with the shipment of goods, are present by comparing all of the text fields of the object for matches against text fields of a checklist associated with the customs authority; and, should a required number text fields match, automatically completing the customs forms for the shipment based on the data of the object.

Optionally, the computer usable non-transitory storage medium is such that the steps additionally comprise: providing documents associated with the completed customs forms to form a document package for the customs authority.

Optionally, the computer usable non-transitory storage medium is such that the steps additionally comprise: automatically transmitting the completed customs form or the document package to the customs authority.

Optionally, the computer usable non-transitory storage medium is such that the document types include one or more of: commercial invoices, packaging lists, airway bills, country of origin, bills of lading, dangerous goods declarations, import permits, materials safety data sheets, and shipping instructions.

Optionally, the computer usable non-transitory storage medium is such that the steps additionally comprise: automatically providing a harmonized system (HS) code for the shipment of goods.

Optionally, the computer usable non-transitory storage medium is such that the steps additionally comprise: automatically obtaining customs tariffs and/or taxes for the shipment of goods.

Optionally, the computer usable non-transitory storage medium is such that the steps additionally comprise: automatically determining whether the shipment of goods has the proper permits required by the customs authority, and if the required permits are not present, automatically sending an alert of the missing permits to at least one party associated with the shipment of goods.

Optionally, the computer usable non-transitory storage medium is such that the steps additionally comprise: should the required number text fields not match, automatically sending an alert that the required text fields are not present to at least one party associated with the shipment of goods.

This document references terms that are used consistently or interchangeably herein. These terms, including variations thereof, are as follows.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page that is accessible over Networks including the Internet.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionalities may be implemented.

A “client” is an application that runs on a computer, workstation or the like and relies on a server to perform some of its operations or functionality.

A “country” is a sovereign nation, which maintains its own customs authority or provides reciprocity to the customs authority of another sovereign nation.

A region is a group of countries that function as a political and economic union with a single set of customs, rules, tariffs, taxes and the like, such as the European Union (EU) formed by twenty-seven member countries.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary environment for the system in which embodiments of the disclosed subject matter are performed;

FIG. 2 is a block diagram of the architecture of the home server of FIG. 1 and the system thereof;

FIG. 3A is a diagram of the document classification unit of FIG. 2;

FIG. 3B is a diagram of RES NET Architecture of FIG. 3A;

FIG. 4 is a diagram of the HS Code Classifier of FIG. 2;

FIG. 5A is a diagram of the document processing modules of FIG. 2;

FIG. 5B is a diagram of the document processing module of FIG. 5A; and,

FIG. 6 is a flow diagram of an example process performed by the system of the disclosed subject matter.

Appendices A-E are attached to this document.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks. These trademarks are the property of their respective owners, and are referenced only for explanation purposes herein.

The present invention provides methods and systems for preparing a shipment for customs clearance, for example, by a national customs authority; include obtaining one or more electronic documents associated with a shipment of goods and obtaining one or more electronic customs forms of a customs authority. The electronic documents are processed by an automated system which recognizes the documents by document type and extracts data from each document, based on its determined document type. The extracted data is merged into an object for all of the electronic forms associated with the shipment of goods, and from this merged object, the obtained customs forms are completed. These completed forms are transmitted to the customs authority directly from the system.

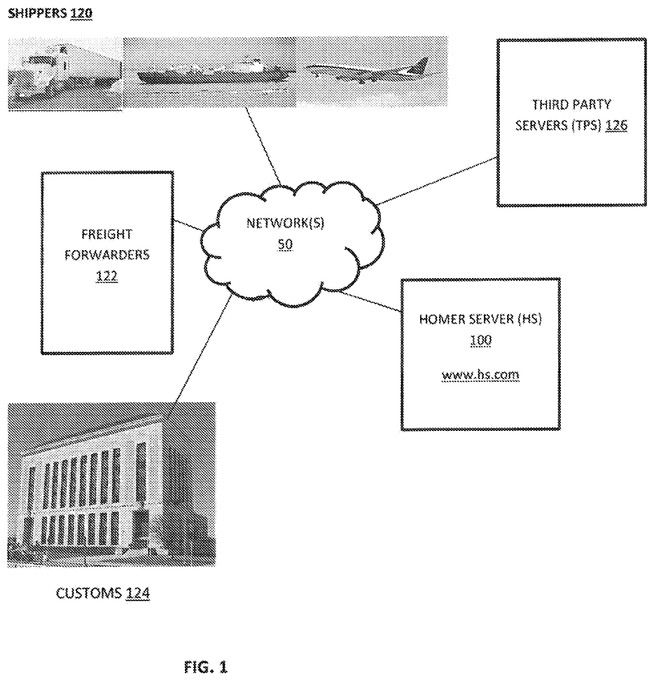

Reference is now made to FIG. 1, which shows an exemplary operating environment, including a network(s) 50 (hereinafter “network”), to which is linked a home server (HS) 100, also known as a home computer, a main server or main computer, these terms used interchangeably herein. The home server 100 also supports a system 100′, either alone or with other, computers, including servers, components, and applications, e.g., client applications, associated with either the home server 100, as detailed below. The network 50 is, for example, a communications network, such as a Local Area Network (LAN), or a Wide Area Network (WAN), including public networks such as the Internet. As shown in FIG. 1, the network 50 is, for example, the Internet. The network 50, although shown as a single network, may be a combination of networks and/or multiple networks including, for example, in addition to the Internet, one or more cellular networks, wide area networks (WAN), and the like. “Linked” as used herein includes both wired or wireless links, either direct or indirect, and placing the computers, including, servers, components and the like, in electronic and/or data communications with each other, either directly or indirectly.

The home server 100 and the system 100′ perform the various processes in accordance with the present invention, as detailed below. The home server 100 is such that it receives documents concerning the goods/items for customs processing and clearance, as well as all forms, data and permits required for customs clearance from parties to the customs clearance process. These parties, link to the network(s) 50 via one or more computers, and include, for example, shippers 120, freight forwarders 122, and customs authorities 124. Third party servers (TPS) 126 of various information providing entities are also linked to the network(s) 50.

The home server (HS) 100 is of an architecture that includes one or more components, engines, modules and the like, for providing numerous additional server functions and operations. The home server (HS) 100 may be associated with additional storage, memory, caches and databases, both internal and external thereto. For explanation purposes, the home server (HS) 100 may have a uniform resource locator (URL) of, for example, www.hs.com. While a single home server (HS) 100 is shown, the home server (HS) 100 may be formed of multiple servers and/or components.

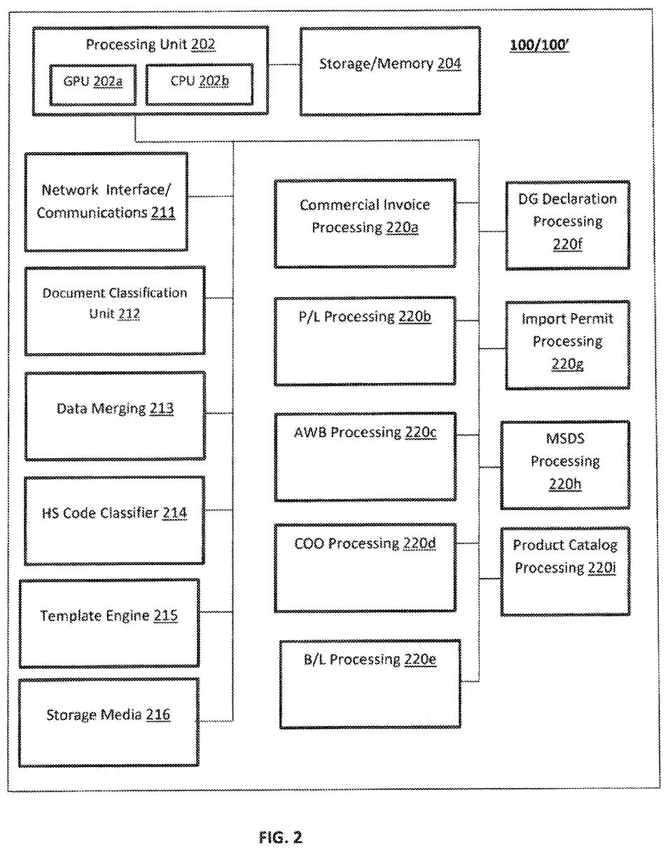

Attention is now directed to FIG. 2, which shows the architecture of the system 100′, for example, in the home server 100. This architecture of the system 100′, as shown, for example, in the home server 100, includes a Processing Unit 202, formed of a graphics processing unit (GPU) 202a formed of one or more processors, and a Central Processing Unit (CPU) 202b, formed of one or more processors. The Processing Unit 202 is electronically connected to storage/memory 204, document processing modules 211-215, storage media 216, and document type processing modules (also known as document type processing units, which are used interchangeably with the document type processing modules) 220a-220i. As used herein, a “module”, for example, includes a component for storing instructions (e.g., machine readable instructions) for performing one or more processes, and including or associated with processors, e.g., the Processing unit 202, for executing the instructions.

While components 204, 211-215, 216, and 220a-220i, are shown within the home server 100, for example, as part of the system 100′, any one or more of these components 204, 211-215, 216 and 220a-220i, may be external to the home server 100, and be linked to the home server 100 from their external location. Additionally, the aforementioned components are linked to each other either directly or indirectly, by wired and/or wireless links, so as to be in electronic and/or data communication with each other.

The Graphics Processing Unit (GPU) 202a is formed of one or more processors, including microprocessors, for performing the home server 100, including the system 100′, functions and operations detailed herein, including controlling the components 211-215, 216 and 220a-220i, and executing the instructions provided and/or obtained therefrom. The GPU 202a processors are, for example, conventional GPUs, such as those used in servers, computers, and other computerized devices, including data processors and hardware processors, for performing the home server 100 and system 100′ functions and operations detailed herein, and include, for example, GPU's such as TITAN RTX™, and GeForce GTX™ 1050, both commercially available from NVIDIA of Santa Clara, Calif.

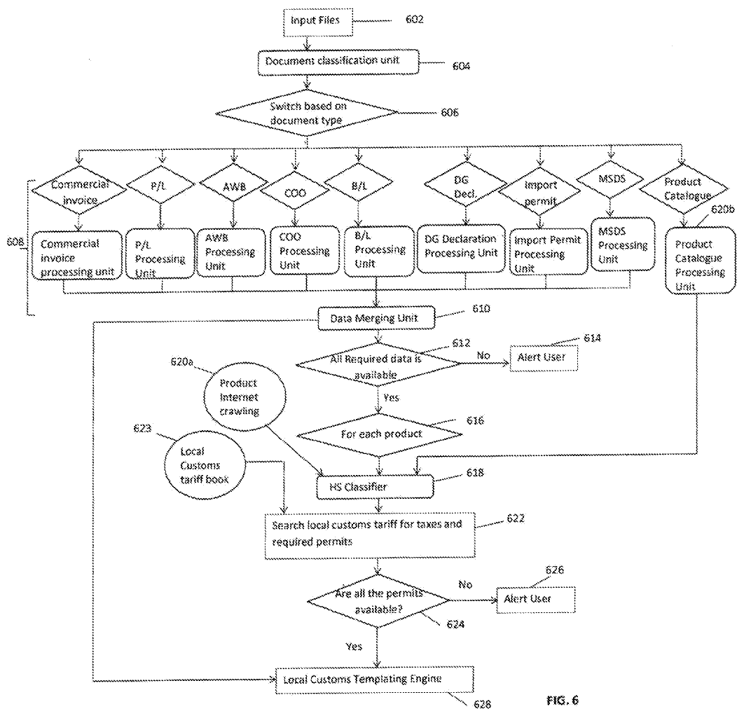

The CPU 202b is formed of one or more processors, including microprocessors, for performing the home server 100 functions and operations detailed herein, including controlling the components 204, 211-215, 216, and 220a-220i, executing the instructions provided and/or obtained therefrom. The Central Processing Unit (CPU) 202 processors are, for example, conventional processors, such as those used in servers, computers, and other computerized devices, including data processors and hardware processors, for performing the home server 100 and system 100′ functions and operations detailed herein. For example, the processors may include x86 Processors from AMD and Intel, Xenon® and Pentium® processors from Intel, as well as any combinations thereof. The storage/memory 204 is associated with the Processing Unit 202 is any conventional storage media. The storage/memory 204 also includes machine executable instructions associated with the operation of the Processing Unit202 and the components 211-215 and 220a-220i, along with the processes and subprocesses shown in FIG. 6, detailed herein. The storage/memory 204 also, for example, stores rules and policies for the system 100′ and the home server 100. The processors of the Processing Unit 202 and the storage/memory 204, although shown as a single component for representative purposes, may be multiple components, and may be outside of the home server 100 and/or the system 100′, and linked to the network 50.

A network interface 211 communicates with the network(s) 50, and includes a data transceiver for receiving data from imagers, and readers, such as those using ocular character recognition (OCR), and the like, for example, from documents associated with each shipment (provided to the network interface 211 as digital representations of the documents), which is input into the system 100′ from various entities associated with each shipping transaction, including, for example, shippers 120, freight forwarders 122 government and regulatory authorities 124, and third parties 126. There is also a data transmitter, for sending messages and alerts to the various entitles associated with the shipment.

A Document Classification Unit 212 reads this input data and determines the type of document which is being input into the system 100′. The Document Classification Unit 212, for example, uses techniques such as deep learning and Artificial Intelligence (AI) to determine the type of document, and may store each determined document by document type to continuously train the document classification unit 212.

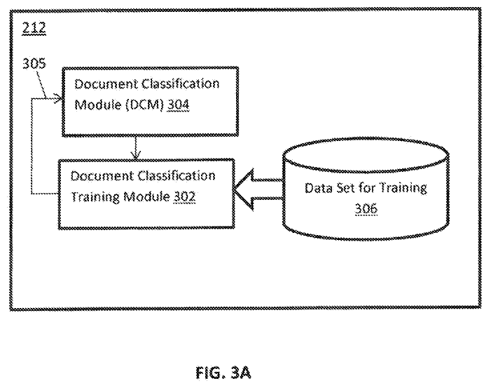

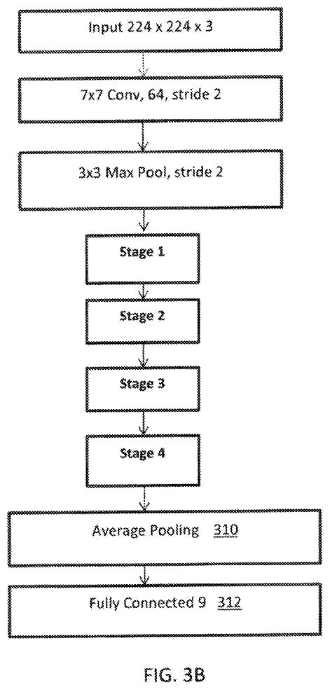

FIG. 3A shows the document classification unit 212 in detail. The document classification unit converts documents to Portable Network Graphics (PNG) images, splitting PNG images into multiple PNG images, where necessary, as well as PDF, EXCEL and WORD, splitting these documents into multiple pages where necessary. Each PNG image and/or PDF, EXCEL or WORD Document, is loaded into the GPU 202a, classified by a neural network. The neural network outputs scores for each type of document. From the scores, the GPU 202a calculates the probability of the image/document being of a certain document type, usable by the system 100′. The image/document is then marked with the document type of the highest probability, and the document type is accepted provided the score is over a predetermined threshold. If below a predetermined threshold, the image/document is subject to manual inspection.

The document classification unit includes a training module 302, linked to a document classifier module 304. The training module updates the document classifier module 304, as frequently as each iteration, the updates indicate by the arrow 305. The training module 302 is fed electronic documents, such as PNG images, each with an assigned document type from one of the documents types, the assigned documents part of an electronic document source or data set 306. These document types may be, for example, the documents types of: Commercial Invoices, Packaging Lists (P/L), Airway Bills (AWB), COO, Bills of Lading (B/L), Declarations, Permits (e.g., Import Permits), Merchandise Data Sheets (MSDS) and Product Catalog listings, as per block 1308. Based on the documents fed to the training module 302, from a data set 306 of documents being of a known classification, the document classification module 304 is trained.

The document classification module 304, as trained by the training module 302, for example, includes a neural network, such as a convolutional neural network (CNN), for classifying the documents. The CNN, is, for example, a neural network such as that disclosed in He, et al., “Deep Residual Learning For Image Recognition,” attached to this document as Appendix A (12 Pages), and which is incorporated by reference herein. The CNN uses architecture of 50 convolutions known as RES NET (available from www.cv-tricks.com), shown in Appendix B, which is also attached to this document, and is incorporated by reference herein. The last layer of the RES NET, as shown in Appendix B, as block 312 from block 310 is “Fully Connected 9” instead of “Fully Connected 1000”, as shown in FIG. 3B, as the document classification module 302, produces nine outputs, corresponding to the document types of: Commercial Invoices, Packaging Lists (P/L), Airway Bills (AWB), COO, Bills of Lading (B/L), Declarations, Permits, Merchandise Data Sheets (MSDS) and Product Catalog listings. The RES NET includes adjustable parameters, which affect the outputs of the CNN.

During training, when one or more documents of known types, from the data set 306, is fed to the document classification training module 302. The training module 302 uses the document classification module 304 to produce nine outputs (FIG. 3B block 312), that represent the predicted probabilities of the document being of each type, for each of the documents. The document classification training module 302 computes a cross entropy loss (CEL) value to evaluate the performance of the Document Classification Module 304. The cross entropy loss function is expressed as:

CEL=Σᵢ₌ₒ^{c}yᵢ log(ŷᵢ)

where,

CEL is a value indicating the Cross Entropy Loss,

yᵢ is 1 if class i is the correct document type (label), otherwise 0,

ŷᵢ is the output, a predicted probability of the input being of class i,

c is the number of outputs, for example, 9 for 9 document classes or types, and,

i is an index of a class.

A back propagation algorithm is then used to compute a gradient of the CEL, with respect to the document classification module's parameters.

An optimization algorithm, such as Stochastic Gradient Descent (SCD) or ADAM, as disclosed in Kingma, et al, “ADAM: A Method For Stochastic Optimization”, pages 1-15, attached hereto as Appendix C (15 Pages), and incorporated by reference herein, uses the computed gradients in order to change the document classification module's RES NET parameters, such that CEL is decreased in the training module 302, resulting in an updated (arrow 305) document classification module 304.

A data merging unit 213 takes all information (data) which it obtains from the document processing modules (or units) 220a-220i, checks the validity of the information, and combines this information into a single object, and typically sends the object for storage, for example, in the storage media 216. The single object includes all information which is available for a shipment.

A Harmonized System or Harmonized Tariff (HS) Classifier 214 provides HS codes, product names and product descriptions for each product of the transaction, as pulled, for example, by ocular character recognition (OCR) from an invoice.

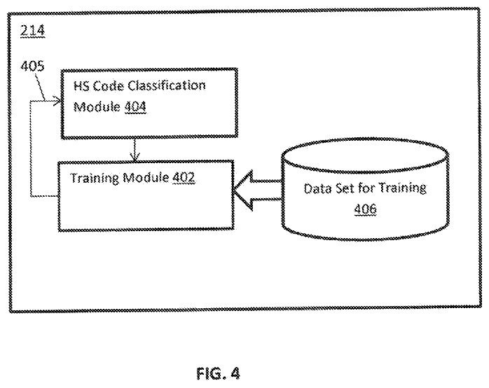

FIG. 4 shows the HS Classifier 214 in detail. The HS Classifier 214 includes an HS Code Classification Training Module 402, linked to an HS Code Classification module 404. The training module 402 updates the HS Code Classification module 404, as frequently as each iteration, the updates indicated by the arrow 405. The training module 402 is fed electronic data items, which include fields, such as product description, origin, unit price, quantity, destination country, each with an assigned HS Code. The assigned data items are part of an electronic document source or data set 406. Based on the data items fed to the training module 402, from a data set 406 being of a known classification, the HS Code Classification module 404 is trained.

The HS Code classification module 404, as trained by the training module 402, for example, includes a neural network, such as a convolutional neural network (CNN), for classifying the data items to HS Codes. The CNN, is, for example, a neural network such as that disclosed in Kim, “Convolutional Neural Networks for Sentence Classification,” in, Proceedings Of The 2014 Conference On Empirical Methods In Natural Language Processing (EMNLP), 2014 (pages 1746-1751), attached to this document as Appendix D (5 Pages), and is incorporated by reference herein. The last layer of the CNN was expanded to have one output per HS Code. The CNN includes adjustable parameters, which affect the outputs of the CNN.

During training, for example, one or more items, each with a known HS Code, from the data set 406, is fed to the HS Code Classification training module 402. The training module 402 uses the HS Code Classification module 404 to produce outputs, which represent the predicted probabilities of each item being of an HS Code, for each of the items. The HS Code Classification training module 402 computes a cross entropy loss (CEL) value to evaluate the performance of the HS Code Classification Module 404. The cross entropy loss function is expressed as:

CEL=Σᵢ₌ₒ^{c}yᵢ log(ŷᵢ)

where,

CEL is a value indicating the Cross Entropy Loss,

yᵢ is 1 if class i is the correct document type (label), otherwise 0,

ŷᵢ is the output, a predicted probability of the input being of class i,

c is the number of outputs, for example, 9 for 9 document classes or types, and,

i is an index of a class.

A back propagation algorithm is then used to compute a gradient of the CEL, with respect to the document classification module's parameters.

An optimization algorithm, such as Stochastic Gradient Descent (SCD) or ADAM (Appendix C), uses the computed gradients in order to change the HS Code classification module's CNN parameters, such that CEL is decreased in the training module 402, resulting in an updated (arrow 405) from the HS Code classification module 404.

A template engine 215, functions to fill out a customs clearance file automatically based on a different template for each customs authority.

Storage media 216 include one or more databases where the data for all of the documents is stored. The storage media 216, for example, is for both temporary and/or permanent storage of data.

Modules, also known as units or computer components, 220a-220i, function to perform the various operations of the system 100′. These modules 220a-220i include stored instructions for execution by the GPU 202a, in order to perform the operations of the system 100′, such as outputting text fields based on the type of document (e.g., electronic document or digital representation of a document), that the respective module 22a-220i is processing. The modules 220a-220i are also programmable from either an internal (local) network or over a wide area or public network such as the Internet, as represented by the Network(s) 50.

A commercial invoice processing module 220a provides instructions to the GPU 202a for processing documents determined, by the document classifier 212, as Commercial invoices, for the shipment.

A Packing List (P/L) processing module 220b provides instructions to the GPU 202a and CPU 202b for processing documents determined, by the document classifier 212, as packing lists (PL), for the shipment.

An Airway Bill (AWB) processing module 220c provides instructions to the GPU 202a for processing documents determined, by the document classifier 212, as airway bills (AWB), for the shipment.

A Country of Origin (COO) processing module 220d provides instructions to the GPU 202a for processing documents determined, by the document classifier 212, as Country of Origin (COO), for the shipment.

A Bill of Lading (B/L) processing module 220e provides instructions to the GPU 202a for processing documents determined, by the document classifier 212, as Bills of Lading (B/L), for the shipment.

A Dangerous Goods (DG) declaration module 220f provides instructions to the GPU 202a for processing documents determined, by the document classifier 212, as Dangerous Goods (DG) declarations, for the shipment.

An Import Permit Processing module 220g provides instructions to the GPU 202a as to the type of permit which has been identified, which import permits are needed for the goods, and if all of the required import permits are present for the goods for the shipment.

A Materials Safety Data Sheet (MSDS) processing module 220h provides instructions to the GPU 202a for processing documents determined, by the document classifier 212, as Materials Safety Data Sheet (MSDS), for the goods of the shipment.

A Product Catalog Processing Module 220i provides instructions to the GPU 202a for obtaining details on the product(s) of the shipment, for example, by obtaining various suppliers' catalogs to obtain product details.

Additional modules (or units) may be present in the system 100′, including, for example, those for handling special instructions, from customers, shippers, freight forwarders, and the like, such as shipping instructions (SI), e.g., (refrigeration, can only travel over sea by a ship), as well as for any documents which may be required due to changing customs laws, regulations, procedures and the like, for various countries.

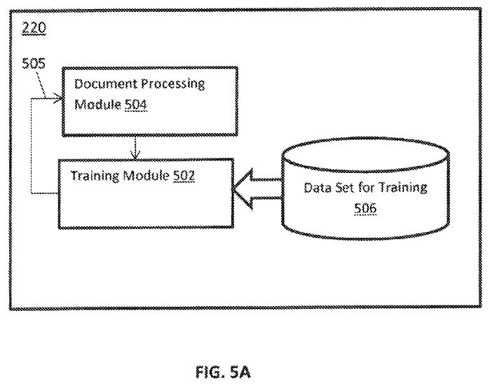

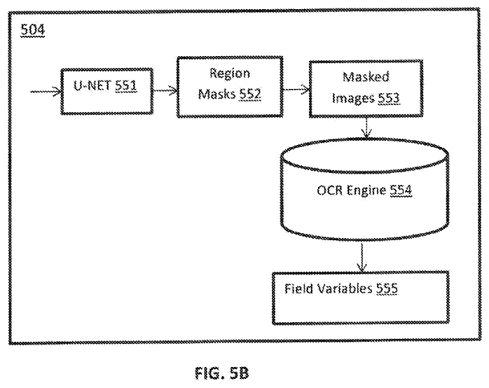

Modules 220a-220i are represented by unit 220 of FIG. 5, in that all of these modules 220a-220i are trained in the same manner but on different document types and different fields. In FIG. 5 the unit 220 is shown in detail. The unit 220 includes a document processing training module 502, linked to a document processing module 504. The training module 502 updates the document processing module 504, as frequently as each iteration, the updates indicate by the arrow 505. The training module 502 is fed electronic documents, such as PNG images, with a correct document mask paired with the original unmasked document, as part of an electronic document source or data set 506. There is one mask for each filed extracted from the document. The mask represents the region in the original document in which the value of the field (text field) is present. Each unit includes its own set of fields. For example, on a Commercial invoice, fields may include, Invoice Number, Invoice Date, Ship To Company Name, Ship To Company Address, Sold To Company Name, Sold To Company Address, Currency, Total Value of Goods, Number of Packages, Description of Goods, and the like.

The document processing module 504, as trained by the training module 502, for example, includes a neural network 551, such as a convolutional neural network (CNN), for object localization, e.g., finding the desired region for a field on a document. The CNN, is, for example, a neural network such as U-NET as disclosed in, Romeberger, et al, “U-Net: Convolutional Networks for Biomedical Image Segmentation,” (2015) pages 1-8,” attached to this document as Appendix E (8 Pages), and is incorporated by reference herein. The CNN uses the architecture as described in the Network Architecture Section of Appendix D, where the desired number of classes is equal to the amount of fields plus one. The plus one is the additional background class. This background class represents a region with a value which is not relevant and therefore, not extracted. For any region except the background region, the regions are used to mask the input document (with different masks for each field and a background mask 552, and a masked image for each field 553). Then, an OCR engine 554, such as Google Cloud Vison OCR engine, is used to extract the value of the field 553 in a digital format. The U-NET includes adjustable parameters, which affect the outputs of the CNN.

During training, one or more set of paired documents, from the data set 506, are fed to the document processing training module 502. The document processing training module 502 uses the document processing module 504 uses the CNN 551 to produce pixel level field type classifications, that represent the predicted probabilities of each pixel being in a region containing a specific field, for each of the fields and the background. The document processing training module 502 computes a pixel-wise cross entropy loss (CEL) value to evaluate the performance of the CNN 411. The cross entropy loss function is expressed as:

$$E = {\sum }_{x ∈ Ω} ω ( x ) log ( {p}_{l ( x )} ( x ) )$$

where,

x represents a single pixel in the original image,

Ω represents the set of all pixels in the image,

ω is the weighting function as defined in section Training in Appendix D,

l(x) is the correct label (field type or background) for pixel x, and,

pₗ₍ₓ₎(x) is the predicted probability of pixel x being of the correct label.

A back propagation algorithm is then used to compute a gradient of the E value, with respect to the document processing module's parameters.

An optimization algorithm, such as Stochastic Gradient Descent (SCD) or ADAM (Appendix C), uses the computed gradients in order to change the document processing module's U-NET parameters, such that E value is decreased in the training module 502, resulting in an updated (arrow 405) document processing module 504.

Attention is now directed to FIG. 6, which shows a flow diagram detailing computer-implemented processes in accordance with embodiments of the disclosed subject matter. Reference is also made to elements shown in FIGS. 1 and 2. The process and subprocesses of FIG. 6 are computerized processes performed by the system 100′. The aforementioned processes and sub-processes are, for example, performed automatically by the processing unit 202 and associated components 204, 211-216 and 220a-220i of the system 100′, and, for example, in real time. Alternately, some of the subprocesses of FIG. 6 may be performed manually. The processes and subprocesses of FIG. 6 can also be performed by software applications such as client-based applications, on a suitably programmed system or computer, with non-transitory storage media.

In FIG. 6, the process begins at block 602, where input files are received by the home server 100 and the system 100′, as digital representations of documents. The input files include, for each shipment and the goods/products therein, for example, commercial invoices, packaging lists (P/L) Airway Bills (AWB), Country of Origin (COO) certificates, Bills of Lading (B/L), Dangerous Goods (DG) declarations, Import Permits, Materials Safety Data Sheets (MSDS), shipper instructions (SI), and the like, as received from shippers 120, freight forwarders 122, governmental authorities 124 and third party servers (TPS) 126, and the like. Alternately, the documents may be in paper, images or the like, and are converted to digital documents (digital representations of the received documents), also known as “electronic documents” by processes such as scanning, Optical Character Recognition (OCR), and the like.

These digital or electronic documents are, input into a document classification unit 212, at block 604, which analyzes the documents (digital representations of the documents), and determines the document type, at block 606, for example, automatically. However, in some cases, manual intervention to determine the document type may be necessary, as detailed above for the document classification unit 212.

The process moves to block 608, where each document for the shipment, whose type was determined at block 606, is, for example, automatically, sent to the appropriate module 220a-220i for processing, which outputs text fields. Text fields include, for example, description of goods, origin, unit price, quantity, destination country, invoice number, invoice date, Ship To Company Name, Ship To Company Address, Sold To Company Name, Sold To Company Address, currency, total value of goods, number of Packages, Shipper's Name and address and other details, Consignee's (customer's) Name and Address, Issuing Carrier's Agent Name and Address and other details, Agent's ITA Code, Account numbers, Port of Departure, Handling Information, weight of goods in shipment, rate classes, rates, volume of goods, charges, Shipper Certifications, bank details, and the like.

The processed documents' text fields are, for example, automatically, input into the data merging unit 213, at block 610. The data merging unit 213 for example, automatically, takes all information (data), e.g., text fields (and may also include electronic documents) which it obtains from the document processing units 220a-22i, combines it into a single object, and typically sends the object for storage, for example, in the storage media 216. The single object includes all information which is available for a shipment, i.e., the shipment of goods associated with the documents being instantly processed.

The process moves to block 612, where the GPU 202a, for example, automatically, determines whether all of the documents and data associated with the shipment, for example, as represented by the object, are present. This subprocess is performed based on stored or otherwise programmed checklists in the storage media 216. The documents, text fields and/or data therein (e.g., from the object) are compared and matched against the requisite checklist, by, for example, the CPU 202b.

Should the match not be acceptable, e.g., a required or threshold number of text fields did not match, at block 612, the process moves to block 614, where an alert is issued to the requisite party, through the network interface 211, for example, automatically, by the CPU 202b. The requisite party will obtain the necessary documents and resend digital representations of these documents to the network interface 211, where the process starts again from block 602.

At block 612, should there be an acceptable match, e.g., a required or threshold number of text fields match, the process moves to block 616, for example, automatically. At block 616, each product of the shipment is isolated, and the data identifying and classifying the product, is sent, for example, automatically, to the HS Classifier 214, at block 618.

At block 620a, keywords for the product are obtained from either the system 100′ or third party servers 126 over the network(s) 50, for example, from third party servers (TPS) 126. Additionally, at block 620b, key words, terms, and/or descriptions of the product are obtained from product catalogs (also, typically from TPS 126), which allow the system 100′ to classify the product via the network(s) 50. Staying at block 618, using the HS Classifier 214, HS classification codes are assigned to each product (good). The product codes assigned to the products are, for example, based on the probabilities produced by the HS Code Classification module 404 (detailed above). The product codes are those based on the particular country or region of the destination of the shipment of the goods. While the processes of blocks 618 and 620a, are for example, performed automatically, manual intervention may be necessary should a key word, term or description not be found in a product catalog, and/or the HS classification code not be found electronically or as per the above description for the HS Code Classification module 404.

The process now moves to block 622, where for each product of the shipment, tariffs for the product are obtained, for example, for tax purposes, from the local customs tariff book (electronic) 623, as well as a check that each product of the shipment has the required permits (also from the book 623) for that country/region of destination. The processes of blocks 622 and 623 are, for example, automatic.

The process moves to block 624, where a check is made, for example, automatically, to determine whether all of the necessary permits for the product, as required by the destination country/region, are available and accompanying the shipment. If no, the process moves to block 626, where an alert is issued, for example, by the CPU 202b, automatically, to the requisite party (e.g., customers, shippers 120, freight forwarders 122), through the network interface 211, for example, automatically. The requisite party will obtain the necessary documents and resend digital representations of these documents to the network interface 211, where the process starts again from block 602.

If all permits are correct and accompanying the shipment, the process moves to block 628, where a local customs templating engine 215, for example, automatically, fills out (completes) the local customs form(s), physical or digital, with the relevant information, such as the product HS classifications, prices, quantities, exporter and importer information and other fields (text fields) required, including, for example, from the object, and assembles all of the required forms (and other documents) into a package. This local customs form (one or more) is obtained from the local customs authority, for example, by the CPU 202b programmed to do so, and is either obtained as an electronic form or rendered as an electronic form from an initially paper or other printed form.

Additionally, at block 628, all information for the shipment, including the filled out forms and document package, is sent to the customs user, such as shippers 120, freight forwarders 122, which will then forward all necessary documents to the requisite customs authority 124. The system 100′ (e.g., the home server 100), for example, receives a response from the shipper 120 and/or freight forwarder 122, whether and when the shipment has cleared customs 124. In some cases, some forms and files from the system 100′ are directly transmitted and submitted to customs authorities 124.

The process may continue and or repeat for other documents associated with the present shipment being processed by the system 100′ or the next set of documents associated with another shipment, for as long as desired or necessary.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination thereof as well as quantum computing More specific examples (a non-exhaustive list) of the computer readable storage medium would include the following: an electrical connection having one or more wires, a portable computer diskette, a hard disk, a random access memory (RANI), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for preparing a shipment for customs clearance comprising:
obtaining one or more electronic documents associated with a shipment of goods;
obtaining one or more electronic customs forms of a customs authority;
automatically classifying each electronic document of the one or more electronic documents into document types for processing based on each classified document type;
automatically processing each document in accordance with its classified document type to obtain one or more text fields, and merging all obtained text fields into an object representing the one or more electronic documents associated with the shipment of goods;
determining, by a processor, whether all of the documents and data associated with the shipment of goods, are present by comparing all of the text fields of the object for matches against text fields of a checklist associated with the customs authority; and,
should a required number text fields match, by a processor, automatically completing the customs forms for the shipment based on the data of the object.

2. The method of claim 1, additionally comprising one or more of: 1) providing documents associated with the completed customs forms to form a document package for the customs authority, and, 2) automatically transmitting the completed customs form or the document package to the customs authority.

3. (canceled)

4. The method of claim 1, wherein the document types include one or more of: commercial invoices, packaging lists, airway bills, country of origin, bills of lading, dangerous goods declarations, import permits, materials safety data sheets, and shipping instructions.

5. The method of claim 1, additionally comprising: automatically providing a harmonized system (HS) code for the shipment of goods.

6. The method of claim 1, additionally comprising: automatically obtaining customs tariffs and/or taxes for the shipment of goods.

7. The method of claim 1, additionally comprising: automatically determining, by a processor, whether the shipment of goods has the proper permits required by the customs authority, and if the required permits are not present, automatically sending an alert of the missing permits to at least one party associated with the shipment of goods.

8. The method of claim 1, additionally comprising: should the required number text fields not match, by a processor, automatically sending an alert that the required text fields are not present to at least one party associated with the shipment of goods.

9. (canceled)

10. A computer system for preparing a shipment for customs clearance comprising:
a reader for reading electronic documents associated with a shipment of goods;
a storage medium for storing computer components; and,
at least one processor for executing the computer components comprising:
a first computer component for obtaining one or more electronic documents associated with the shipment of goods, and one or more customs forms of a customs authority;
a second computer component for automatically classifying each electronic document of the one or more electronic documents into document types for processing based on each classified document type, based on data from the one or more electronic documents read by the reader;
a third computer component for automatically processing each document in accordance with its classified document type to obtain one or more text fields, based on said each document being read by the reader, and merging all obtained text fields into an object representing the one or more electronic documents associated with the shipment of goods;
a fourth computer component for determining, whether all of the documents and data associated with the shipment of goods, are present by comparing all of the text fields of the object for matches against text fields of a checklist associated with the customs authority; and,
a fifth computer component responsive to a determination that a required number text fields match, automatically completing the customs forms for the shipment based on the data of the object.

11. The computer system of claim 10, additionally comprising: a sixth computer component for automatically transmitting the completed customs form to the customs authority.

12. The computer system of claim 10, wherein the document types include one or more of: commercial invoices, packaging lists, airway bills, country of origin, bills of lading, dangerous goods declarations, import permits, materials safety data sheets, and shipping instructions.

13. The computer system of claim 10, additionally comprising: a seventh computer component for automatically providing a harmonized system (HS) code for the shipment of goods.

14. The computer system of claim 10, additionally comprising: an eighth computer component for automatically obtaining customs tariffs and/or taxes for the shipment of goods.

15. The computer system of claim 10, additionally comprising: a ninth computer component for automatically determining whether the shipment of goods has the proper permits required by the customs authority, and if the required permits are not present, automatically sending an alert of the missing permits to at least one party associated with the shipment of goods.

16. The computer system of claim 10, wherein the fourth computer component is additionally configured to respond, when the required number text fields do not match, by automatically sending an alert that the required text fields are not present to at least one party associated with the shipment of goods.

17. The computer system of claim 10, wherein the fifth computer component includes a template engine for automatically completing the customs forms for the shipment based on the data of the object.

18. A computer usable non-transitory storage medium having a computer program embodied thereon for causing a suitably programmed system to preparing a shipment for customs clearance, by performing the following steps when such program is executed on the system, the steps comprising:
obtaining one or more electronic documents associated with a shipment of goods;
obtaining one or more electronic customs forms of a customs authority;
automatically classifying each electronic document of the one or more electronic documents into document types for processing based on each classified document type;
automatically processing each document in accordance with its classified document type to obtain one or more text fields, and merging all obtained text fields into an object representing the one or more electronic documents associated with the shipment of goods;
determining whether all of the documents and data associated with the shipment of goods, are present by comparing all of the text fields of the object for matches against text fields of a checklist associated with the customs authority; and,
should a required number text fields match, automatically completing the customs forms for the shipment based on the data of the object.

19. The computer usable non-transitory storage medium of claim 18, wherein the steps additionally comprise one or more of: 1) providing documents associated with the completed customs forms to form a document package for the customs authority, and, 2) automatically transmitting the completed customs form or the document package to the customs authority.

20. (canceled)

21. The computer usable non-transitory storage medium of claim 18, wherein the document types include one or more of: commercial invoices, packaging lists, airway bills, country of origin, bills of lading, dangerous goods declarations, import permits, materials safety data sheets, and shipping instructions.

22. The computer usable non-transitory storage medium of claim 18, wherein the steps additionally comprise one or more of: 1) automatically providing a harmonized system (HS) code for the shipment of goods, and, 2) automatically obtaining customs tariffs and/or taxes for the shipment of goods.

23. (canceled)

24. The computer usable non-transitory storage medium of claim 18, wherein the steps additionally comprise one or more of:
automatically determining whether the shipment of goods has the proper permits required by the customs authority, and if the required permits are not present, automatically sending an alert of the missing permits to at least one party associated with the shipment of goods; and,
should the required number text fields not match, automatically sending an alert that the required text fields are not present to at least one party associated with the shipment of goods.

25. (canceled)
